(19) United States
(12) Patent Application Publication
(10) Pub. No.: US 2003/0183332 A1
(43) Pub. Date: Oct. 2, 2003

(54) Screen printed thermal expansion standoff

(76) Inventor: Charles E. Simila, Richardson, TX (US)

Correspondence Address: Thomas W. Adams, Renner, Otto, Boiselle & Sklar, L.L.P., 19th Floor, 1621 Euclid Avenue, Cleveland, OH, 44115, US

(21) Appl. No.: 10/106,545

(22) Filed: Mar. 26, 2002

(51) Int. Cl. B32B 31/00

(52) U.S. Cl. 156/291; 428/161

(57) ABSTRACT

The present invention relates to a method of adhering a component to a substrate with a controlled bondline, and to a device made by the method, including steps of providing a substrate; applying a first adhesive in a plurality of selected locations on a surface of the substrate; curing the first adhesive to form a plurality of structures; applying a second adhesive over selected groupings of the plurality of structures, the second adhesive at least partially surrounding and covering the structures in the selected groupings; and placing a component on the second adhesive such that the second adhesive is compressed and the component rests on the structures in at least one of the selected groupings.

### TECHNICAL FIELD

The present invention relates to a method for attachment of a component, such as an electrical component, to a substrate including use of a standoff or spacer to maintain a constant bondline between the component and the substrate.

### BACKGROUND ART

In the design and assembly of microelectronic assemblies, efforts are made to select components, e.g., an electrical component such as an IC memory chip, and substrates, e.g., a printed circuit board, which have similar coefficients of thermal expansion (CTE). The component may be attached to the substrate using a conductive or non-conductive adhesive, for example an epoxy paste. Thermally and electrically conductive adhesives have been used. The adhesive may be applied to the substrate by a screen printing process or by a needle dispensing process. The component is placed in contact with the adhesive on the substrate and the adhesive is cured.

One problem in the prior art results from differences in thermal expansion of substrate and component. If there is a significant mismatch between the coefficients of thermal expansion of the component and the substrate, a large bondline is needed. Another problem results from differences in hardness or rigidity of substrate and component. If one of these parts is relatively soft and deformable while the other is hard and rigid, a large bondline is needed. In both cases the large bondline is needed to avoid fracture of the bondline and to keep the component from coming loose from the substrate as a result of mechanical stress resulting from thermal excursions or from other mechanical deformations. For example, thermal excursions may range from about −55° C. to about +125° C., or more, for a typical integrated circuit which may be used in an aircraft. The adhesive attachment must remain flexible enough to prevent the adhesive from peeling off the component or substrate (termed adhesive failure), or from separating internally (termed cohesive failure).

In the prior art, bondline distances often have been maintained by including spacer particles of a known size in the adhesive used to form the attachment of the component to the substrate. This approach requires the maintenance and use of a separate, custom type of adhesive having a specifically sized spacer particle, dedicated to an individual use for a particular bondline. The adhesive cannot be applied to other manufacturing applications in which the spacer particles are unneeded, are incompatible or are the wrong size. In addition, use of custom adhesives results in an increase in costs and inventory, since a separate adhesive must be maintained for each different bondline in use.

In another approach, spacer particles and the adhesive have been separately attached to a substrate. This approach requires a separate step of attaching the spacer particles, and the spacers particles are typically composed of materials with different characteristics, in particular different thermal expansion properties, than the paste which is combined with the spacer particles. The use of such spacer particles degrades bondline flexibility and/or adhesion strength. The spacer particles may also adversely or unpredictably affect thermal or electrical conductivity in the completed assembly, due to irregular spacing of the particles.

In yet another approach, epoxy pastes have been applied using a screen as a printing tool. One problem with using screens is the tendency for spacer particles of larger size to clog the screen mesh, resulting in erratic paste transfer to the substrate. If spacer particles are kept small to facilitate passage thru the screen mesh, then they are of insufficient size to be effective in maintaining the required bondline thickness when the component is placed onto the deposit of paste, since there is no repeatable constraint on squeeze-out of paste until the component rests on the largest spacer particles present. If the mesh openings are made larger to accommodate spacer particles of greater size, then larger mesh wires are required to provide strength to the screen. The large wires produce a pattern of undulations in the paste deposit which tend to trap bubbles between the paste and the component placed on the paste, degrading adhesion, electrical conductivity, and thermal conductivity at the paste-to-component interface. Thus, a screen printing method does not provide a consistent adhesion bondline when used together with large spacer particles.

Another approach has been to form an array of electrical contact pads and posts on either of the component or the substrate, and to place a layer of adhesive between, followed by pressing together the component and substrate to bring the pads and posts into electrical contact and to simultaneously squeeze out the adhesive. This approach requires placing the pads and posts in a precisely ordered array and then to precisely align the component and the substrate to obtain proper registration of each pad to the respective post.

Adhesives which are thermoplastic pose the problem that, during the aforementioned thermal excursions, the thermoplastic may become either embrittled by the cold or fluidized by the heat, in either case loss of adhesion may result.

Thus, a need continues for a method of adhering a component to a substrate with a controlled bondline, which avoids the pitfalls of the prior art.

### DISCLOSURE OF INVENTION

In one embodiment, the present invention relates to a method of adhering a component to a substrate with a controlled bondline, including steps of providing a substrate; applying a first adhesive in a plurality of selected locations on a surface of the substrate; curing the first adhesive to form a plurality of structures; applying a second adhesive over selected groupings of the plurality of structures, the second adhesive surrounding and covering the structures in the selected groupings; and placing a component on the second adhesive such that the second adhesive is compressed and the component rests on the structures in at least one of the selected groupings.

In another embodiment, the present invention relates to a device including a component adhered to a substrate with a controlled bondline, the device including a substrate having a support surface; a component supported on the support surface; and a controlled bondline disposed between and adhered to both the support surface and the component, wherein the controlled bondline is defined by a plurality of structures formed of a cured first adhesive, and a second adhesive surrounds each of the plurality of structures.

Thus, the present invention solves the problem of obtaining a controlled bondline, that is, a reliable, reproducible bondline, between a component and a substrate. The present invention provides a method of adhering a component to a substrate with a controlled bondline, in which the bondline can be predetermined to withstand thermal excursions to which the finished part comprising the component and substrate may be subjected. The present invention avoids the pitfalls of the prior art, is economical and avoids the use of a plurality of specialized adhesives which are not generally applicable to other uses.

### BRIEF DESCRIPTION OF DRAWINGS

FIG. 1 is a schematic cross-sectional view of a component adhered to a substrate with a controlled bondline, in accordance with the present invention.

FIGS. 2-12 are schematic cross-sectional views depicting a substrate and a component at specific points in a process of being adhered together, to result in formation of a device such as that shown in FIG. 1, in accordance with the present invention.

FIG. 13 is a plan view of a stencil which may be used to apply a first adhesive material in accordance with the present invention.

FIG. 14 is a plan view of a stencil which may be used to apply a second adhesive material in accordance with the present invention.

FIG. 15 is a flow diagram schematically depicting the steps of a method of adhering a component to a substrate with a controlled bondline, in accordance with the present invention.

FIG. 16 is a perspective concept view of the basic elements of a device in accordance with the present invention.

It should be appreciated that for simplicity and clarity of illustration, elements shown in the Figures have not necessarily been drawn to scale. For example, the dimensions of some of the elements are exaggerated relative to each other for clarity. Further, where considered appropriate, reference numerals have been repeated among the Figures to indicate corresponding elements.

### MODES OF CARRYING OUT THE INVENTION

As used herein, the term “bondline” is defined as the distance between the bottom surface of an attached component and the top surface of a substrate to which the component is attached or is to be attached. The bondline is determined by the thickness of the material, e.g., an adhesive, disposed between the component and the substrate. Minimum preferred bondline thicknesses for individual components and substrates may be calculated or determined by those of skill in the art based on known characteristics of the specific combination of component, substrate and adhesive to be used in a given application.

The term “controlled bondline” as used herein refers to a bondline having a selected thickness which may be reliably and repeatably obtained, and in which the adhesive bond is capable of withstanding thermal excursions to which the finished product is expected to be exposed during its operational life. Thus, the controlled bondline has a desirable thickness and adhesive bonding capability.

As used herein, the term “thermal excursion” refers to temperature changes to which a part, such as a part comprising the component and substrate described herein, may be exposed during the operational life of the part. A thermal excursion includes a range of temperatures to which the part may be exposed for some period of time during the operational life. Temperature changes in thermal excursions include, for example, seasonal temperature changes and temperature changes due to changes latitude and changes in altitude.

The disclosed range and ratio limits, in both the specification and the claims, may be combined.

In accordance with a first embodiment of the present invention, there is provided a method of adhering a component to a substrate with a controlled bondline. The method includes steps of providing a substrate; applying a first adhesive in a plurality of selected locations on a surface of the substrate; curing the first adhesive to form a plurality of structures; applying a second adhesive over selected groupings of the plurality of structures, the second adhesive surrounding and covering the structures in the selected groupings; and placing a component on the second adhesive such that the second adhesive is compressed and the component rests on the structures in at least one of the selected groupings.

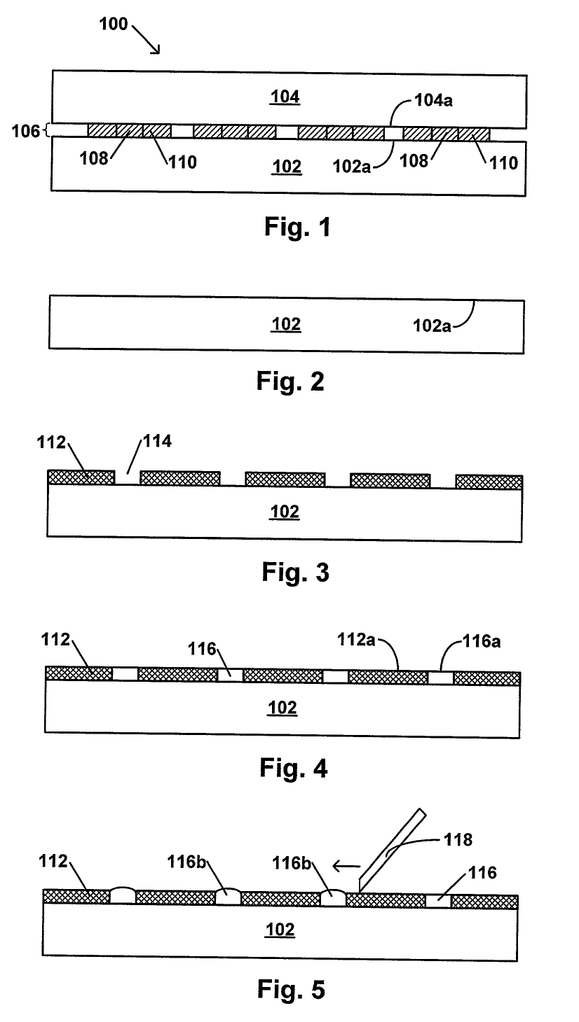

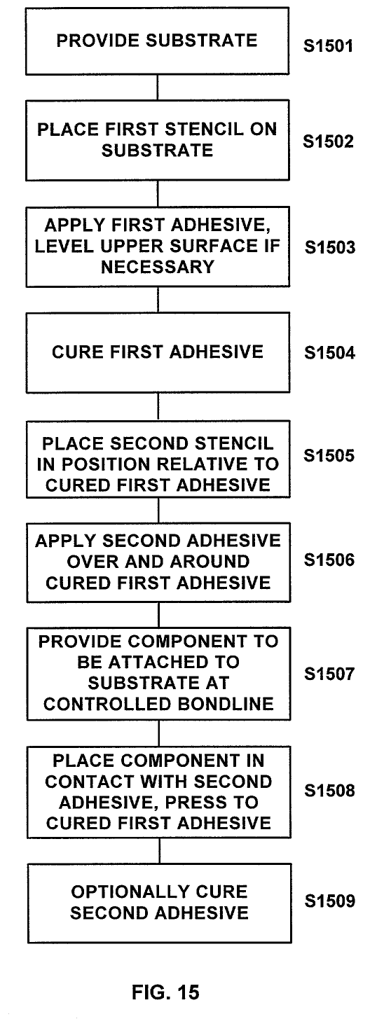

This embodiment of the present invention is described in the following with reference to FIGS. 1-16. FIG. 15 is a flow diagram schematically depicting the steps of a method of adhering a component to a substrate with a controlled bondline.

FIG. 1 is a schematic cross-sectional view of a device 100 including a substrate 102 to which a component 104 is adhered with a controlled bondline 106, in accordance with the present invention. In FIG. 1, the device 100 includes the controlled bondline 106 which is obtained by use of a structure 108 formed from a first adhesive and a pad 110 formed from a second adhesive. The structure 108 also may be sometimes referred to as a post. The term “structure” is used in the following disclosure in order to avoid limitation of the scope of this term which might be inferred from use of “post”. The term “pad” refers to adhesive which is applied subsequent to formation of the structure, and which is associated with the structure. The pad may completely or partially surround individual structures or groups of structures. Thus, the term “pad” is not limited to a continuous layer of adhesive.

In accordance with the present invention, the controlled bondline 106 can be obtained by controlling the thickness of both the adhesive 108 and the pad 110. In one embodiment described below, the controlled bondline 106 can be obtained by controlling the thickness of the adhesive 108, which is formed first from a curable first adhesive. The first adhesive is formed and cured to form the adhesive 108 having a selected and controlled thickness, which becomes the controlled bondline 124, as is described in further detail below.

As shown in FIG. 15, in the first step, S1501, a substrate 102 is provided. FIG. 2 schematically shows a suitable, exemplary substrate 102. The present invention is not particularly limited by the choice of substrate. The substrate 102 may be any device to which the component 104 is to be attached. In one embodiment, the substrate 102 and the component 104 have a different coefficient of thermal expansion, and the device 100, including the combined substrate 102 and component 104, are subject to thermal excursions during the operational life of the attachment.

In one embodiment, the substrate 102 may be a circuit board, and in another, it may be a printed circuit board (PCB). In other embodiments, the substrate 102 may be a device such as a PCB, a multi-chip module, a power hybrid, an engine controller, a receive or transmit module, a microcontroller, an opto-electronic device, an analog or a mixed-signal module, a resistor, a capacitor, a cardguide or any other similar substrate to which a component may be adhered. In an embodiment in which the substrate is a circuit board or PCB, it may be made from a material such as alumina, beryllia, sapphire, low temperature co-fired ceramic (LTCC), high temperature co-fired ceramic (HTCC), KOVAR®, FR4®, GaAs, stainless steel, BT epoxy, ceramic-filled PTFE, aluminum, glass, polyimide, other suitable materials known in the art, and combinations of two or more of these. Examples of components are provided below.

In the second step of the method of the present invention, shown in FIG. 15 as step S1502, a first stencil 112 is placed on the substrate 102, as shown in FIG. 3. The first stencil 112 includes a plurality of first openings 114. The first stencil 112 may have first openings 114 of any desired shape or size. In one embodiment, the first stencil 112 includes a regular array of first openings 114. In one embodiment, the regular array of first openings 114 includes groupings, such as pairs, sets of three, four, or more first openings 114, in which each grouping of openings is arrayed in some pattern in the first stencil.

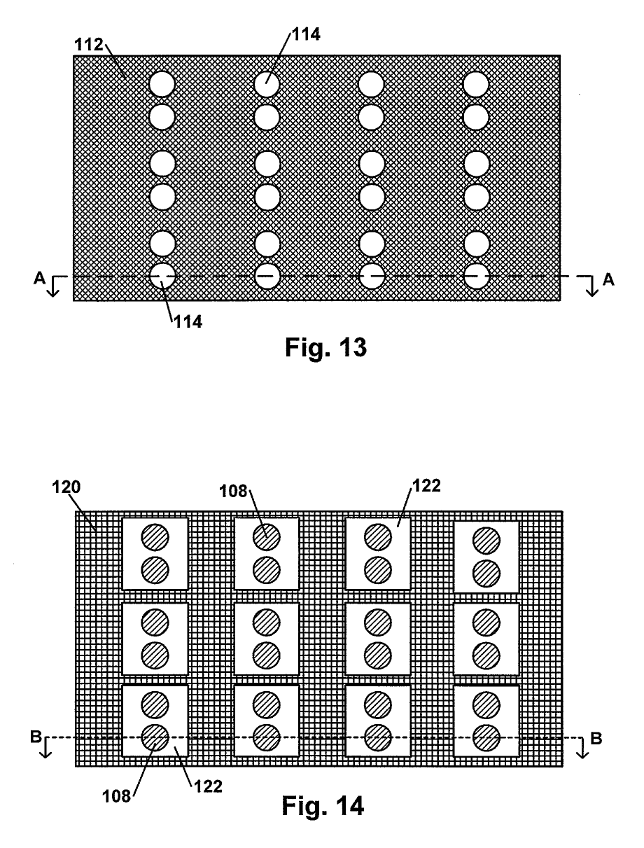

A plan view of the exemplary first stencil 112 is shown in FIG. 13. The first stencil 112 shown in FIG. 3 is a cross-sectional view taken at line A-A of the first stencil 112 shown in FIG. 13. The first stencil shown in FIG. 13 includes an array of first openings, in which the first openings are grouped in pairs, and the pairs are arranged lengthwise in rows. This arrangement is exemplary only, any suitably selected arrangement of first openings being within the scope of the invention.

The first openings 114 in the first stencil 112 may have a size appropriate to the size of the device 100. Thus, in one embodiment, the first openings 114 may range in size from about 0.01 mm to about 25 mm. In another embodiment, the first openings 114 may range in size from about 0.1 mm to about 10 mm. In another embodiment, the first openings 114 may range in size from about 0.5 mm to about 5 mm. In another embodiment, the first openings 114 may range in size from about 0.1 mm to about 1 mm.

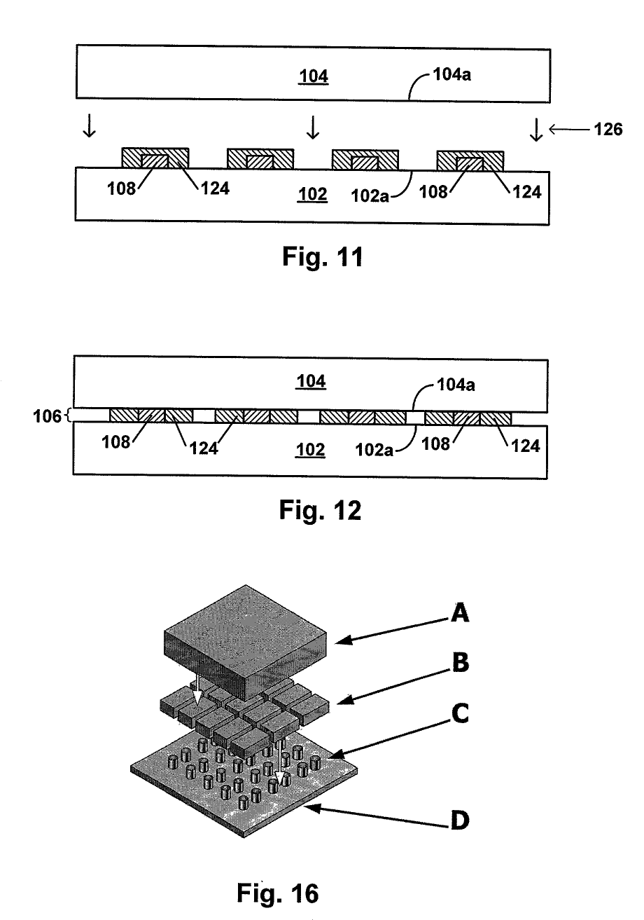

The first openings 114 in the first stencil 112 may have any shape appropriate to the use to which the device 100 is to be put. In one embodiment, illustrated in FIG. 11, the first openings 114 are round, and the first adhesive with which the openings will be filled will have a cylindrical shape. The first openings 114, may be round, oval, square, rectangular, triangular, polygonal, or some other shape. The shape of the first openings 114 is not particularly limited, other than by practical considerations such as ease of preparation of the stencil, ease of use and cleaning of the stencil, and ease of application of a second adhesive thereover, as will be described below.

The first stencil may be made of any suitable material. For example, the first stencil may be formed of a polymeric material, a metal, a ceramic or other suitable material. The metal may be, for example, stainless steel, brass, Alloy 42 (42% Ni, 58% Fe) or Invar (36% Ni, 64% Fe).

In one embodiment, prior to placement on the substrate 102, the underside of the first stencil 112, which will contact or be placed against the substrate 102, is coated with a coating which aids in preventing adhesive or other stencil-applied material from leaking, seeping or being forced between the underside of the first stencil 112 and the surface of the substrate 102. In one embodiment, the coating is an emulsion designed for this purpose. Such emulsions are commercially available, and may be proprietary formulations. In one embodiment, the coating is an emulsion including polyvinyl alcohol or polyvinyl acetate or a mixture thereof. In one embodiment, the emulsion is enhanced with additional photo-sensitive polymeric components. Examples of such photo-sensitive polymeric components include acrylate oligomers and acrylate monomers.

In one embodiment, the photo-sensitive emulsion may be applied as a film or as a controlled-thickness wet layer. The emulsion should be capable of coating, wetting and adhering to the stencil material. Suitable commercially available emulsions include POLY-PLUS® SRX, available from Kiwo, Inc., Seabrook, Tex., and MAGNA/CURE® MAX-R, available from Chromaline in Duluth, Minn.

The coating subsequently may be removed, e.g., by rinsing with an appropriate solvent, such as water or a water-alcohol mixture, in order to avoid interfering with subsequent steps of the method.

In the third step of the method of the present invention, shown in FIG. 15 as step S1503, a first adhesive 116 is applied to the substrate 102 at selected locations determined by the positions of the first openings 114 in the first stencil 112, an example of which is shown in FIG. 4. The first adhesive 116 may be applied by means of any device known in the art and appropriate for use with the first stencil 112, based on the size of the first openings 114 and the overall size of the first stencil 112. Thus, for example, the first adhesive 116 may be applied to selected locations on the substrate 102 as determined by the first stencil 112, by spreading the first adhesive 116 with a doctor knife, a squeegee (metal, plastic or rubber), a spatula, a pump-type printhead or a bladder pump.

In one embodiment, the first adhesive 116 is a curable adhesive. The first adhesive 116 may be radiation curable, moisture curable, free-radical curable or heat curable. Any other known curing method may be used. The radiation for curing may include visible light, ultraviolet, electron beam, actinic, ionizing radiation, x-ray, gamma-ray, beta-ray, short- or long-wave infrared, microwaves or any other type of radiation curing known in the art. The equipment for generating these forms of thermal cure or radiation cure are well known in the art.

In one embodiment, curing is carried out at a temperature in the range from ambient to about 260° C., in another embodiment, from about 10° C. to about 100° C., in another embodiment from about 20° C. to about 80° C., and in yet another embodiment from about 35° C. to about 55° C.

The cure time may be suitably selected as needed. In one embodiment, the cure time ranges from about 30 seconds to about 120 minutes. In another embodiment, the cure time ranges from about 1 minute to about 60 minutes.

The viscosity of the first adhesive may be suitably selected based on the size of the first openings 114 in the first stencil 112. In one embodiment, the viscosity of the first adhesive prior to curing is in the range from about 100 to about 20,000 cps. In another embodiment, the viscosity of the first adhesive prior to curing is in the range from about 1,000 to about 6,000 cps. The rheology of the uncured adhesive may be of a thixotropic nature to permit formation of the desired post and pad shapes upon which the component to be attached will be placed. In one embodiment, the thixotropic index of the adhesive may be in the range from about 1:3 to about 1:7.

The first adhesive may be any curable adhesive known in the art. Suitable first adhesives include, for example, one or more epoxies, polyolefins, polyamides, polyesters, polyester copolymers, polyurethanes, polysulfones, polyvinylidine chloride, styrene-maleic anhydride copolymers, styrene-acrylonitrile copolymers, ionomers based on sodium or zinc salts or ethylene methacrylic acid, polymethyl methacrylates, acrylic polymers and copolymers, polycarbonates, polyacrylonitriles, ethylene-vinyl acetate copolymers, and mixtures of two or more thereof.

In one embodiment, the first adhesive is a heat-curable adhesive. Heatcurable adhesives are activated on exposure to heat. For example, heat-curable adhesives may be activated by driving off water or solvent through the heating process. Alternatively, a heat-curable adhesive may be cross-linked or crystallized on exposure to heat. Examples of such adhesives include phenolic and amino resins, nitrile and neoprene rubbers, epoxy resins, certain isocyanate polymers and certain vinyl monomers such as alkyl acrylates, alkyl alkylacrylates and alkyl 2-cyanoacrylates. Alkyl groups include substituted or unsubstituted, branched or unbranched alkyl groups having from one to about 10 carbon atoms. Suitable substitutions include halogens, ether moieties, thioether moieties and aromatic groups. Mixtures of these heat-curable adhesives are also contemplated.

In one embodiment, the first adhesive is a curable resin including an oligomer such as epoxy acrylate, urethane acrylate, polyester acrylate, and polyether acrylate, or mixtures of two or more thereof. In one embodiment, the acrylate of these oligomers is an alkylacrylate as defined above. In one embodiment, this resin is used in solution in a polyfunctional acrylate monomer, and the oligomer is of an ultraviolet-curable type. In one embodiment, the first adhesive may include a thermosetting resin capable of forming a hard cured resin such as silicone resin, melamine resin, or polyimide resin.

The radiation curable adhesive may include a photoinitiator. Suitable photoinitiators include 4′-isopropyl-2-hydroxy-2-methylpropylacetophenone, 2,2-dimethoxy-2-phenylacetophenone, benzoin isobutyl ether, 1-hydroxyhexyl phenyl ketone or the like, alone or in combination of two or more.

In one embodiment, the first adhesive is filled with a thermally or electrically conducting material, or a material which is both thermally and electrically conductive. In one embodiment, the filler is a metal. Metals generally provide both thermal and electrical conductivity. In one embodiment, the metal is one or more of silver, copper, aluminum, gold, brass, iron, tungsten, platinum, nickel, palladium, niobium, molybdenum, lead and bismuth. In addition, the first adhesive could be filled with carbon, carbon fibers, graphite, graphite fibers, or similar carbon-based fillers, which may provide both thermal and electrical conductivity.

In one embodiment, the adhesive is an electrically conductive polymer, such as polyaniline, polypyrrole, polyfuran, polythiophene or polyparaphenylene vinylene, polyphenylene vinylene, polyacetylene or substituted derivatives of such polymers. Exemplary substitution of such polymers includes substituents with unshared pairs of electrons on atoms within the group, such as hydroxyl, alkoxyl or amino substitution. Other conductive polymers known in the art may be used.

In one embodiment, the first adhesive is desired to have only thermal conductivity. Appropriate thermally conductive fillers which may be added to a resin include, for example, ceramic materials such as alumina and beryllia.

In one embodiment, the first adhesive is a structural adhesive. In one embodiment, the first adhesive is one or a mixture of phenolic, heat curing epoxy, two-part epoxy, one part self curing acrylic, one part radiation curing acrylic, primer activated acrylic, two-part acrylic, two-part urethane, heat curing polyimide or heat curing bis-maleimide.

In one embodiment, the first adhesive is an epoxy filled with one or more of the above noted metals, with silver being particularly useful. In accordance with this embodiment, the conductive epoxy has sufficient conductivity that a 15 mil length sample of the liquid conductive epoxy having cross-sectional dimensions of 50 mil by 2 mil would have a resistance of less than about 100 ohms along its length while having a viscosity of less than about 100,000 cps. The conductive epoxy can be a mixture of a first liquid comprising a base epoxy and a second liquid comprising a hardener.

A suitable epoxy is a silver-containing epoxy sold under the product name Ablestik Ablebond 8175A by Ablestik, Inc. of Rancho Dominguez, Calif. According to its MSDS, Ablebond 8175A contains about 1 to about 10 wt % of a rubber modified epoxy resin, about 1 to about 5 wt % of 1,4-bis(2,3-epoxypropoxy) butane, about 5 to about 15 wt % of diglycidylether of bispheno-F, and up to about 85 wt % silver flake. Ablebond 8175 has a viscosity at 25° C. of about 73 Kcps, a volume resistivity of about 0.0003 ohm-cm, a coefficient of thermal expansion (CTE) below 80° C. of 65×10⁻⁶ in/in/deg, and a CTE above 80° C. of 25×10⁻⁶ in/in/deg.

In one embodiment, the first adhesive 116 is applied at a selected bondline thickness and the first adhesive 116 is substantially free of particles having a particle size greater than about 90% of the selected bondline thickness. Thus, the particles of conductive filler which may be included in the first adhesive do not determine the minimum thickness of the first adhesive 116, and do not affect the thickness of the controlled bondline 106. In another embodiment, the first adhesive 116 is free of particles having a particle size greater than about 50% of the selected thickness.

As shown in FIG. 4, in one embodiment, the first adhesive is applied in a manner such that the upper surface 116a of the first adhesive 116 is flush with a plane defined by the upper surface 112a of the first stencil 112. However, as a result of changes such as temperature changes which may occur before, during or after curing, or volume changes which may occur during or as a result of curing, the first adhesive 116 may have an upper surface 116b which extends above the place defined by the upper surface 112a of the first stencil 112. In such case, a leveling tool 118 may be used to form a level surface 116a in the first adhesive 116. The leveling tool 118 may be a knife, or any other suitable device capable of cutting through the first adhesive, before or after curing. The step of leveling is optional, if needed to obtain a uniform and level upper surface on the adhesives formed by the first adhesive. The step of leveling may be carried out either prior to or subsequent to curing the first adhesive 116.

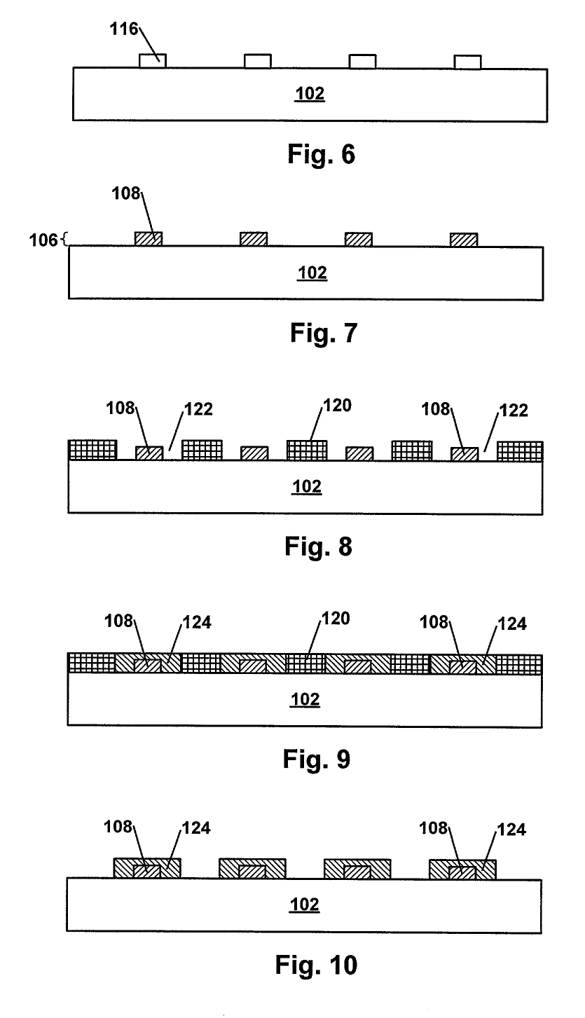

Upon application of the first adhesive 116, the structure shown in FIG. 6 is obtained.

In the fourth step of the present invention, shown in FIG. 15 as step S1504, the first adhesive 116 is cured. The first adhesive may be cured by any of the above-described methods which is appropriate to the type of adhesive used. Upon curing of the first adhesive 116, the structure shown in FIG. 7 is obtained. The structure shown in FIG. 7 includes the substrate 102 and a plurality of the adhesives 108.

The structures 108 formed by curing the first adhesive 116 define the controlled bondline 106 which will be obtained by the present invention. Since the adhesives 108 have been formed by curing the first adhesive 116 which was located by the first openings 122 in the first stencil 120, each of the adhesives has a height or thickness which, in one embodiment, is defined by the thickness of the first stencil 120. In another embodiment, the thickness or height of the adhesives 108, and thereby the controlled bondline 106, is substantially the same as the thickness of the first stencil 120.

In the fifth step of the method of the present invention, shown in FIG. 15 as step S1505, a second stencil 120 is placed on the substrate 102, for example, as shown in FIG. 8. The second stencil 120 may include a plurality of second openings 122. The second stencil 120 may have second openings 122 of any desired shape or size, provided that each of the second openings 122 are larger than at least one of the adhesives 108 formed by the cured first adhesive 116. In other words, at least one of the adhesives 108 should fit within the confines of each second opening, and enough space should surround each adhesive to provide for placement of a second adhesive, as described in more detail below. In one embodiment, the second stencil 120 includes a regular array of openings 122. In one embodiment, the regular array of openings 122 includes groupings, such as pairs, sets of three, four, or more openings, in which each grouping is arrayed in a pattern in the first stencil.

A plan view of the exemplary second stencil 120 is shown in FIG. 14. The second stencil 120 shown in FIG. 8 is a cross-sectional view taken at line B-B of the second stencil 120 shown in FIG. 14. The second stencil 120 shown in FIG. 14 includes an array of second openings 122, in which the second openings 122 are grouped in rows, and in which each of the second openings 122 is large enough and is located to include a pair of the adhesives 108. This arrangement is exemplary only, any suitably selected arrangement of openings being within the scope of the invention.

In one embodiment, the second stencil is thicker than the first stencil, as is shown in FIG. 8. It is noted that FIG. 8 does not directly compare the first stencil 112 to the second stencil 120, but the adhesives 108 formed by the first stencil 112 have a height which is substantially the same as the thickness of the first stencil 112, which was discussed above and is shown in FIG. 4.

In one embodiment, prior to placement on the substrate 102, the underside of second stencil 120, which will contact or be placed against the substrate 102, is coated with a coating which aids in preventing the adhesive or other stencil-applied material from leaking, seeping or being forced between the underside of the second stencil 120 and the surface of the substrate 102. Such coating may be any coating such as described above with respect to the first stencil 112. The same or a different coating from that used with the first stencil 112 may be used with the second stencil 120.

In the sixth step of the method of the present invention, shown in FIG. 15 as step S1506, a second adhesive 124 is applied to the substrate 102 at selected locations determined by the second openings 122, surrounding the adhesives 108, as shown in FIG. 9. The second adhesive 124 may be applied by means of any device known in the art and appropriate for use with the second stencil 120, based on the size of the second openings 122 and the overall size of the second stencil 120. Thus, for example, the second adhesive 124 may be applied to selected locations on the substrate 102 as determined by the second stencil 120, by spreading the second adhesive 124 with any of the devices identified above with respect to application of the first adhesive 116.

The second adhesive 124 may be any adhesive known in the art. In one embodiment, the second adhesive 124 may be any of the adhesives identified above with respect to the first adhesive 116. In one embodiment, the second adhesive 124 is a curable adhesive. In one embodiment, the second adhesive 124 may be any of the curable adhesives identified above with respect to the first adhesive 116. In one embodiment, the second adhesive 124 is the same adhesive as the first adhesive 116.

The second adhesive may include a conductive filler, as described above with respect to the first adhesive.

In one embodiment, the second adhesive 124 is applied as a continuous pad over selected groupings of the structures 108 formed by curing of the first adhesive, as shown in FIG. 9. As shown, the second adhesive 124 both surrounds and covers each of the structures 108. The second adhesive 124 thus extends above the top of the adhesives 108. As a result, when the component 104 is later applied for attachment, the component 104 will first contact the second adhesive 124, as described in more detail below.

In other embodiments, the second adhesive 124 may be applied as a discontinuous pad, in which the second adhesive contacts or is associated with parts of one or more of the structures 108, but in which at least a part of one or more of the structures 108 remains free of the second adhesive.

After the second adhesive 124 is applied, the second stencil 120 is removed, leaving the structure shown in FIG. 10. The structure shown in FIG. 10 includes the substrate 102, the adhesives 108 and the second adhesive 124. The second adhesive 124 is uncured at this point in the process.

In the seventh step of the method of the present invention, shown in FIG. 15 as step S1507, a component 104 is provided for attachment to the substrate 102 by the controlled bondline 106. The component 104 may be any component which is needed to be applied to the substrate 102. For example, the component 104 may be any device which needs to be attached to the substrate and which has or is expected to have a CTE different from that of the substrate.

As noted, the magnitude of even a small CTE mismatch between the component 104 that substrate 102 may result in damage to or loss of the bondline 106 between the component 104 and substrate 1-2, if the bondline 106 is too small. The bondline 106 may be increased as needed, by increasing the thicknesses of the first and second stencils (112 and 120, respectively) appropriately.

The component 104 may include such active devices as an integrated circuit, a memory chip, a photon or infrared sensor array, a resistor, a capacitor, a switch, a solenoid, a cardguide, or any other electronic, electrical or electromechanical device which needs be attached to a substrate as described herein. The component 104 may be a micro-electromechanical system using semiconductor materials such as silicon, gallium arsenide (GaAs), indium phosphide (InP), silicon-germanium (SiGe), indium arsenide (InAs), gallium antimonide (GaSb) and aluminum antimonide (AlSb), among others.

In another embodiment, the component 104 may be a package or chip carrier bearing a face-up or flipchip active device. The active devices may be made from materials such as, for example, alumina, beryllia, sapphire, LTCC, HTCC, KOVAR®, FR4®, GaAs, Invar, Alloy 42, copper-molybdenum-copper, stainless steel, BT epoxy, ceramic-filled PTFE, aluminum, glass, polyimide, other suitable materials known in the art, and combinations of two or more of these.

In another embodiment, the component may be a passive component such as a block or panel of an iron-filled polymeric or rubber radio frequency (RF) absorber. In another embodiment, the component may be a block or panel of a radar-dispersive or radar-absorbent material.

The present invention is not limited to any particular component or substrate, or to any particular combination of component and substrate. the present invention is most useful for any component and substrate between which there is a difference in the CTE at any given use temperature or range of use temperatures.

In one embodiment, the present invention includes additional steps. While these additional steps are not considered essential to the present invention, they may be useful and may be needed for use with some combinations of first and second adhesives, substrate and component.

In one embodiment, the present invention includes an eighth step. In the eighth step of the method of the present invention, shown in FIG. 15 as step S1508, the component 104 is brought or placed into contact with the elements of the substrate 102, as shown schematically in FIG. 11. In one embodiment, the component 104 first contacts the second adhesive 124. As the component 104 is moved downward (as downward is shown in FIG. 11 in the direction of arrows 126, toward the substrate 102), it contacts the second adhesive 124, and forces the second adhesive 124 to spread outwardly. As the component 104 is continued to be pressed toward the substrate 102, in one embodiment, it forces substantially all of the second adhesive 124 away from the top of the adhesives 108, as a result of which the component 104 comes into contact with the adhesives 108. It is recognized that some finite quantity of the second adhesive 124 may remain on top of the adhesives 108, but this amount will be quite small, in this embodiment. Thus, in one embodiment, the step of placing the component 104 on the substrate 102 includes first bringing the component 104 into adhering contact with the second adhesive 124, and applying a force to the component 104 such that the component 104 contacts the cured first adhesive 116 which forms the adhesives 108.

FIG. 12 shows an example of the component 104 pressed down into contact with both the second adhesive 124 and the adhesives 108. In this embodiment, the second adhesive 124 has been spread outward slightly, as shown schematically by the increase in side-to-side width of the second adhesive 124 depicted in FIG. 11 as compared to that shown in FIG. 12. As shown schematically in FIG. 12, the component 104 is substantially in contact with the adhesives 108. This contact forms the controlled bondline 106.

In another embodiment, not shown, a greater amount of the second adhesive 124 remains between the top of the adhesives 108 and the bottom face of the component 104. As long as the amount of the second adhesive 124 between the top of the adhesives 108 and the bottom of the component 104 remains substantially constant, a controlled bondline can be obtained. In one embodiment, conductive particles in the second adhesive have a size which obtains a controlled bondline and a controlled thickness of the second adhesive 124 between the top of the adhesives 108 and the bottom of the component 104. However, unless the second adhesive includes many uniformly sized particles providing a specific minimum thickness on a plurality of adhesives 108, the controlled bondline may not be obtained. If the thickness between the top of the adhesives 108 and the bottom of the component 104 is not maintained relatively constant, the bondline may not be as uniform and reproducible as desired.

In one embodiment, the second adhesive 124 is not cured. Where the second adhesive 104 is an adhesive having a high degree of tack over a range of temperatures to which the device 100 is expected to be exposed, it may be unnecessary to use a curable second adhesive 124. If the second adhesive 124 remains uncured, the final device 100 will appear as in FIG. 12.

In one embodiment, the present invention includes a ninth step. In the ninth step of the present invention, shown in FIG. 15 as step S1509, the second adhesive 124 is cured to form the pads 110. The second adhesive 124 may be cured by any of the above-described methods which is appropriate to the type of adhesive used. Upon curing of the second adhesive 124, the structure shown in FIG. 1 is obtained. The structure shown in FIG. 1 includes the substrate 102, a plurality of the adhesives 108, a plurality of pads 110 formed of the cured second adhesive 124, and the component 104. The component 104 is separated from the substrate 102 by the controlled bondline 106. Thus, in one embodiment, the cured first adhesive and the second adhesive form a substantially unitary controlled bondline 106.

In one embodiment, both the first adhesive and the second adhesive are screen printable.

As described above, in one embodiment, the first stencil 112 has first openings 114 corresponding to a plurality of selected locations at which the adhesives 108 are to be formed, and the second stencil 120 has second openings 122 corresponding to the plurality of selected locations at which the adhesives are formed, and the second openings 122 are larger than the first openings 114.

In another embodiment, the process of the present invention includes adhering a component to a substrate with a controlled bondline 106 including steps of providing a substrate 102; placing a first stencil 112 on the substrate 102; applying a first adhesive 116 in a plurality of selected locations defined by openings 114 in the first stencil 112 on a surface of the substrate 102; curing the first adhesive 116 to form a plurality of structures 108; placing a second stencil 120 on the substrate 102; applying a second adhesive 124 over selected groupings of the plurality of structures 108, the selected groupings defined by second openings 122 the second stencil 124, the second adhesive 124 surrounding and covering the structures 108 in the selected groupings; placing a component 104 on the second adhesive 124 such that the second adhesive 124 is compressed and the component 104 rests on the structures 108 in at least one of the selected groupings. When the first adhesive 116 is cured, it defines a substantially unitary controlled bondline. As described above, in one embodiment, at least one of the first adhesive 116 and the second adhesive 124 contains a thermally and/or electrically conductive component. As a result of this process, the component 104 is securely adhered to the substrate 102 at a controlled bondline 106. Each of these steps is substantially the same as the corresponding steps described in detail above with respect to the first embodiment of the process.

In another embodiment, the process of the present invention adheres a component 104 to a substrate 102 with a controlled bondline 106, by steps including providing a substrate 102; placing a first stencil 112 on the substrate 102; applying a first adhesive 116 in a plurality of selected locations 114 defined by the stencil 116 on a surface of the substrate 102; curing the first adhesive 116 to form a plurality of structures 108 defining the controlled bondline 106; placing a second stencil 120 on the substrate 102; applying a second adhesive 124 over selected groupings of the plurality of structures 108, the selected groupings defined by the second stencil 120, the second adhesive 124 surrounding and covering the structures 108 in the selected groupings; and placing the component 104 on the second adhesive 124 such that the second adhesive 124 is compressed and the component 104 rests on the structures 108 in at least one of the selected groupings. In one embodiment, the second stencil 120 is thicker than the first stencil 112 and at least one of the first adhesive 116 and the second adhesive 124 contains a thermally and/or electrically conductive component. As a result of this process, the component 104 is securely adhered to the substrate 102 at a controlled bondline 106. Each of these steps is substantially the same as the corresponding steps described in detail above with respect to the first embodiment of the process.

In one embodiment, the present invention relates to a device 100, as shown in FIG. 1. In one embodiment, the device 100 includes a component 104 adhered to a substrate 102 with a controlled bondline 106. The device 100 further includes a support surface 102a on the substrate 102, as shown, e.g., in FIGS. 1, 2, 11 and 12. The component 104 is supported on the support surface 102a at a controlled bondline 106, as shown in FIG. 1. The controlled bondline 106 is disposed between and adhered to both the support surface and a bottom surface 104a of the component 104, as shown in, e.g., FIGS. 1 and 12. In one embodiment, the controlled bondline 106 is defined by a plurality of structures 108 formed of a cured first adhesive 116, and a second adhesive 124 surrounds each of the plurality of structures 108, as shown in FIGS. 1 and 9-12.

In one embodiment, the first adhesive 116 and the second adhesive 124 are substantially the same adhesive. In one embodiment, at least one of the first adhesive 116 and the second adhesive 124 contains a thermally and/or electrically conductive component.

In another embodiment, the present invention relates to a device 100 including a component 104 adhered to a substrate 102 with a controlled bondline 106. An example of the device 100 is shown in FIG. 1. In this embodiment, the device 100 includes a substrate 102 having a support surface 102a and a component 104 supported on the support surface 102a. The support is provided by a controlled bondline 106 disposed between and adhered to both the support surface 102a and the component 104. In this embodiment, the controlled bondline 106 is defined by a plurality of structures 108 formed of a cured first adhesive 116, and a second adhesive 124 surrounds each of the plurality of structures 108 and at least one of the first adhesive 116 and the second adhesive 124 contains a thermally and/or electrically conductive component.

In one embodiment of the present invention, the component 104 and the substrate 102 have substantially different coefficients of thermal expansion, and the controlled bondline 106 remains adhered to both the component and the substrate through thermal excursions to which the device may be subjected in use. In one embodiment, the thermal excursions are in the range from about −55° C. to about +125° C. In another embodiment, the thermal excursions may be in the range from about −40° C. to about 110° C. The thermal excursions may result, for example, from use of the device 100 on an aircraft, in which the device 100 may be exposed to temperatures as low as about −55° C. during normal flight, and may be exposed to direct sunlight while on the ground, and thereby be exposed to temperatures in excess of about 110° C. In an embodiment of the device intended for use in spacecraft, the temperature range of the thermal excursions may be even greater, ranging from about −200° C. to about +225° C. Thus, the device 100 may be subject to temperature excursions of such magnitudes.

The first stencil 112 and the second stencil 120 may be of any size suitable for the application in which they are employed, from a few inches to several feet in width.

The thicknesses of the first stencil 112 and the second stencil 120 range from about 0.1 mm to about 5 mm, and the thickness of the second stencil ranges from about 0.15 mm to about 6 mm, in which the thickness of the second stencil is equal to or greater than the thickness of the first stencil. In another embodiment, the thickness of the first stencil 112 ranges from about 0.2 mm to about 2 mm, and the thickness of the second stencil 112 ranges from about 0.25 mm to about 2.5 mm, in which the thickness of the second stencil is equal to or greater than the thickness of the first stencil.

FIG. 16 is a perspective conceptual view of the basic elements of a device in accordance with the present invention. FIG. 16 shows, in perspective, an exploded view of the basic elements of the present invention, including a component A, a second adhesive B, a first adhesive C formed into cylindrically shaped adhesives and located on a substrate D. Each of these elements A-D are substantially the same as those described above with respect to FIGS. 1-12.

While the invention has been described in conjunction with specific embodiments herein, it is evident that many alternatives, modifications and variations will be apparent to those skilled in the art in light of the foregoing description. Accordingly it is intended to embrace all such alternatives and modifications in variations as for within the spirit and broad scope of the appended claims.

What is claimed is:

1. A method of adhering a component to a substrate with a controlled bondline, comprising:
providing a substrate;
applying a first adhesive in a plurality of selected locations on a surface of the substrate;
curing the first adhesive to form a plurality of structures;
applying a second adhesive over selected groupings of the plurality of structures, the second adhesive surrounding and covering the structures in the selected groupings; and
placing a component on the second adhesive such that the second adhesive is compressed and the component rests on the structures in at least one of the selected groupings.

2. The method of claim 1, further comprising curing the second adhesive.

3. The method of claim 1, wherein the first adhesive and the second adhesive are screen printable.

4. The method of claim 1, wherein the first adhesive is applied by placing a first stencil on the substrate.

5. The method of claim 4, wherein the second adhesive is applied by placing a second stencil on the substrate.

6. The method of claim 5, wherein the second stencil is thicker than the first stencil.

7. The method of claim 5, wherein the first stencil has first openings corresponding to the plurality of selected locations, and the second stencil has second openings corresponding to the plurality of selected locations, wherein the second openings are larger than the first openings.

8. The method of claim 1, wherein the first adhesive and the second adhesive are substantially the same adhesive.

9. The method of claim 1, wherein when cured, the first adhesive and the second adhesive form a substantially unitary controlled bondline.

10. The method of claim 1, wherein the second adhesive is not cured.

11. The method of claim 1, wherein at least one of the first adhesive or the second adhesive comprises at least one material which is thermally conductive, electrically conductive or both.

12. The method of claim 1, wherein the step of placing a component comprises first bringing the component into adhering contact with the second adhesive, and applying a force to the component such that movement of the component is stopped by the cured first adhesive.

13. The method of claim 1, further comprising a step of leveling the first adhesive.

14. A method of adhering a component to a substrate with a controlled bondline, comprising:
providing a substrate;
placing a first stencil on the substrate;
applying a first adhesive in a plurality of selected locations defined by the stencil on a surface of the substrate;
curing the first adhesive to form a plurality of structures;
placing a second stencil on the substrate, wherein the second stencil defines selected groupings of the plurality of structures;
applying a second adhesive over the selected groupings defined by the second stencil, the second adhesive surrounding and covering the structures in the selected groupings; and
placing a component on the second adhesive such that the second adhesive is compressed and the component rests on the structures in at least one of the selected groupings.

15. The method of claim 14, wherein the second stencil is thicker than the first stencil.

16. The method of claim 14, wherein the first adhesive and the second adhesive are substantially the same adhesive.

17. The method of claim 14, wherein when cured, the first adhesive defines a substantially unitary controlled bondline.

18. The method of claim 14, wherein at least one of the first adhesive or the second adhesive comprises at least one material which is thermally conductive, electrically conductive or both.

19. A method of adhering a component to a substrate with a controlled bondline, comprising:
providing a substrate;
placing a first stencil on the substrate;
applying a first adhesive in a plurality of selected locations defined by the stencil on a surface of the substrate;
curing the first adhesive to form a plurality of structures defining a controlled bondline;
placing a second stencil on the substrate, wherein the second stencil is thicker than the first stencil and the second stencil defines selected groupings of the plurality of structures;
applying a second adhesive over the selected groupings defined by the second stencil, the second adhesive surrounding and covering the structures in the selected groupings; and
placing a component on the second adhesive such that the second adhesive is compressed and the component rests on the structures in at least one of the selected groupings,
wherein at least one of the first adhesive or the second adhesive comprises at least one material which is thermally conductive, electrically conductive or both.

20. A device comprising a component adhered to a substrate with a controlled bondline, comprising:
a substrate having a support surface;
a component supported on the support surface; and
a controlled bondline disposed between and adhered to both the support surface and the component,
wherein the controlled bondline is defined by a plurality of structures formed from a cured first adhesive and a second adhesive which contacts each of the plurality of structures.

21. The device of claim 20, wherein the first adhesive and the second adhesive are substantially the same adhesive.

22. The device of claim 20, wherein at least one of the first adhesive or the second adhesive comprises at least one material which is thermally conductive, electrically conductive or both.

23. A device comprising a component adhered to a substrate with a controlled bondline, comprising:
a substrate having a support surface;
a component supported on the support surface; and
a controlled bondline disposed between and adhered to both the support surface and the component,
wherein the controlled bondline is defined by a plurality of structures formed of a cured first adhesive, and a second adhesive surrounds each of the plurality of structures and at least one of the first adhesive or the second adhesive comprises at least one material which is thermally conductive, electrically conductive or both.
